(19) United States
(12) Patent Application Publication
(10) Pub. No.: US 2006/0143125 A1
(43) Pub. Date: Jun. 29, 2006

(54) Method and system for electronic billing and reconciliation

(76) Inventors: Matt A. Cartwright, Haywards Heath (GB); Olivier B. Sauser, Jouars Pontchartrain (FR)

Correspondence Address: MCDERMOTT, WILL & EMERY LLP, 227 WEST MONROE STREET, CHICAGO, IL, 60606-5096, US

(21) Appl. No.: 11/226,580

(22) Filed: Sep. 13, 2005

Related U.S. Application Data
(60) Provisional application No. 60/609,526, filed on Sep. 13, 2004.

(51) Int. Cl. G06Q 40/00

(52) U.S. Cl. 705/40

(57) ABSTRACT

A system and method for generating and providing an electronic billing statement to a client including a client computer, a travel agent computer, a financial service provider computer and an electronic billing and reconciliation computer for receiving a first billing data file from the travel agent computer and a second billing data file from the financial services provider computer, generating an electronic billing statement and providing the electronic billing statement to the client computer.

### CROSS REFERENCE TO RELATED APPLICATIONS

The present application claims the benefit of U.S. Provisional Application No. 60/609,526, filed Sep. 13, 2004.

### TECHNICAL FIELD

The present subject matter relates to travel related transactions. More specifically, to systems and methods for centralized billing and reconciliation processes relating to electronic billing for travel transactions.

### BACKGROUND

Business travel account products are centrally billed cardless accounts provided by financial services providers and typically set up with travel agents or agencies for use by companies to charge, monitor and track travel of employees, designated individuals or groups of people conducting company business. A business travel account enables employee travelers to book and charge travel related expenses, such as air and rail expenses, in the course of their employment.

In existing business travel account systems and processes, users typically interact with a travel agent or agency to book travel transactions. The company employee or user contacts the travel agent or agency to book travel transactions using the company's business travel account as payment. The travel agent then books the requested travel with a travel supplier. In existing business travel accounts, a financial services provider typically generates and issues a billing statement for booked travel itineraries to a customer based on information and data received from the travel supplier and travel agent. The travel supplier submits a travel supplier charge file requesting payment for booked travel transactions and the travel agent submits a travel agent travel itinerary file which includes the travel itinerary and associated travel agent costs, e.g., travel agent commission. The billing statement is typically generated after both the travel supplier charge file and travel agent itinerary file are received and matched. The financial services provider generates a billing statement that is based on the travel agent charge file augmented by a corresponding and matching travel supplier charge file. The corporate customer then receives a billing statement having detailed information about all travel related transactions charged to a business travel account number and matched during a billing period.

Existing business travel account systems and processes suffer from drawbacks that can make them ineffective and inefficient. Often, travel supplier charge file and travel agent travel itinerary files are not synchronized, and are not generated and submitted to the financial services provider at the same time. This lack of synchronization in receiving the travel supplier charge files and travel agent travel itinerary files can be problematic where the end of a billing period arrives and both the travel supplier charge file and travel agent travel itinerary file have not been received by the financial services provider. This can result in incomplete information and unposted or unbilled travel transactions on the billing statement at the end of the billing period.

If the travel supplier has not received both a travel supplier charge file and/or a travel agent travel itinerary file by the end of the billing period, the financial services supplier may be forced to generate a billing statement that lacks complete travel itinerary details and/or travel supplier charges. If the billing statement lacks detailed and complete information about the billed travel transactions, the customer may delay payment of the billing statement while the customer confirms the billed travel transactions. Also, a financial service provider may need to carry over open travel transactions to the next billing period until matching travel agent itinerary files and travel supplier charges are received that will permit detailed information on the billing statement. This can negatively impact the financial services provider's cash flow position since the financial services provider must typically settle travel supplier charges with the travel supplier upon receipt of the travel supplier charge file regardless of whether a billing statement has been issued to a customer or whether a travel agent travel itinerary has also been received.

### SUMMARY

There is provided a system and method to generate a centralized, detailed and customized electronic billing statement based on billing information received from a financial services provider as well as billing information received from a travel agent or agency. The generation of the electronic billing statement advantageously permits a financial service provider to expedite the generation and submission of a billing statement that includes all of the relevant billing data, including billing data from the travel agent or agency. Further, the expedited electronic billing statement may result in expedited payment of the billed transactions by the responsible customer. Accordingly, the financial services provider can generate an electronic billing statement for transactions based on a travel agent record or data file, instead of a travel supplier charge, and not does not have to wait for receipt of both the travel supplier charge data and travel agent data.

There is provided a computer-readable medium, such as a server, mainframe or other computer platform, having computer-executable instructions for providing electronic billing statements. The computer-readable medium enables the performance of a) receiving a first billing data file from a travel agent or agency; b) receiving a second billing data file from a financial services provider; c) generating an electronic billing statement based on the received first and second billing data files; and d) providing the electronic billing statement to a customer.

There is also provided a method for booking and electronically billing travel related transactions including the steps of a) creating a travel transaction request at a first computer; b) transmitting the travel transaction request to a second computer; c) generating, at the second computer, a first billing data file in response to the travel transaction request; d) transmitting the first billing data file to a billing computer; e) generating, at a third computer, a second billing data file; f) transmitting the second billing data file to the billing compuer; g) generating, at the billing computer, an electronic billing statement based on the received first and second billing data files; and h) providing the electronic billing statement to a customer.

It is an objective to provide a system and process where a financial services provider can expedite the generation of an electronic billing statement through the use of billing data files received from a travel agent or travel agency and billing data files received from a financial services provider.

It is another objective to provide a system and process where a financial services provider can expedite the generation of an electronic billing statement incorporating billing data files from multiple sources resulting in improved cash flow for the financial services provider.

It is also an objective to provide a process and system for centrally electronically billing a customer directly from a plurality of billing data files.

It is further an objective to provide a process and system that provides a client or customer with a consolidated and customized electronic billing statement incorporating client specific data to enable centralized payment of travel expenses and transactions, as well as other expenses billed through a financial services provider.

It is an objective to provide a process and system that enables a client or customer to centrally receive and pay electronic billing statements for travel expenses, as well as financial services expenses, having customized detailed management information on the billing statement.

It is also an objective to provide a process and system for generating an electronic billing statement that accurately reflects travel transactions booked during a billing period along with complete travel agent transaction data instead of waiting to receive a travel supplier charge record of file.

It is further an objective to provide a process and system for expediting the generation of a billing statement for faster payment to the financial services provider of the billed transactions which results in improved float position for the financial services provider since travel transactions can be billed to the client before the travel supplier has submitted a travel supplier charge to the financial services provider for payment.

Additional objects, benefits, advantages and novel features of the subject matter will be set forth in part in the description which follows, and in part will become apparent to those of ordinary skill in the art upon examination of the following drawings, or may be learned by practice, production or operation of the subject matter. The objects and advantages of the concepts and subject matter may be realized and attained by means of the methodologies, instrumentalities and combinations particularly pointed out in the appended claims.

### BRIEF DESCRIPTION OF THE DRAWINGS

The drawings and figures depict one or more implementations in accord with the present concepts and subject matter, by way of example only, not by way of limitation. In the figures, like reference numerals refer to the same or similar elements. The present subject matter and description may be better understood when read in connection with the accompanying drawings, figures or diagrams, of which:

FIG. 1 illustrates a system that can implement an electronic billing and reconciling process for travel transactions and financial services transactions, according to one aspect of the present subject matter.

### DETAILED DESCRIPTION

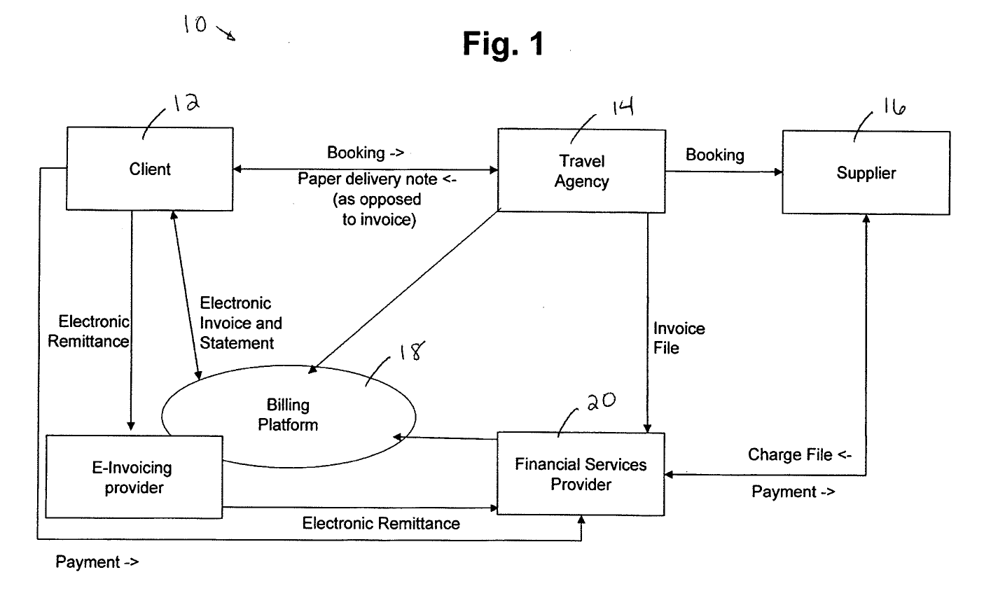

FIG. 1 illustrates a block diagram of an overall system and application process flow 10 that can be used to implement an improved electronic billing and reconciling process for travel transactions as well as other financial service transactions, according to one aspect of the present subject matter. Generally, the overall system 10 can include a client and client computer or network 12, a travel agent or travel agent office and related computer or network 14, one or more travel supplier computers or networks 16, a standalone electronic billing and reconciliation platform 18, a financial service provider 20 and related computer or network 20, and internet communications links and direct communications links for the transmission of data between each of the identified parties, computers and networks as shown in FIG. 1. The system and process 10 permits a financial services provider to generate a centralized, detailed and customized electronic billing statement based on or driven by billing data and information received from both the travel agent or travel agent office computer or network 14 and the financial service provider network or system 20. The generation of the electronic billing statement advantageously permits the financial service provider, via the electronic billing and reconciliation platform 18, to expedite the generation and submission of the billing statement at the end of a billing period to the client computer or network 12, which can result in expedited payment of the electronically billed transactions.

The client 12 contacts a designated travel agent 14 in order to book a travel transaction that will be billed to a company business travel account previously set up by the financial services provider 20 and the client's company or employer. The client 12 is an authorized individual that can contact the travel agent 14 to submit travel or booking requests. The client 12 can be an individual authorized to submit travel or booking request, such as an employee or company administrator, or termed customer. The client 12 can contact the travel agent 14 by any of various known means, including visiting the travel agent in person, a telephone, a facsimile or user computer (not shown) connected to the client's computer or network 12. The travel agent 14 can have one or more machines that run or execute one or more software applications, including a web interface application and a business travel account software application that permit the travel agent 14 to communicate with one or more travel suppliers 16, the electronic billing platform 18 and the financial services provider 20.

The client 12 can provide a traveler profile or customer specific information that identifies the client 12 and company to the travel agent 14. The information submitted by the client 12 can include name of traveler, the traveler's company cost center, project code, etc. The amount and type of data and information provided by the client 12 to the travel agent 14 preferably includes all information and data that was previously defined and agreed to as necessary or desired by the business travel account company and the financial services provider 20. The amount and type of information collected will vary according to the specific needs of the company and financial services provider 20.

The travel agent 14 can access a business travel account number that corresponds to information submitted by the client 12 in order to correlate any booked travel itinerary to the accessed business travel account number. The accessed account number may or may not be displayed or shared with the travelers depending on the arrangement between the company and the financial services provider 20.

The travel agent 14 is able to receive and capture the client's desired travel request. In one aspect, the travel agent 14 can create the travel request via a travel office software application which may be loaded on the travel agency computer or network 14. The travel agent 14 will enter the client's travel request which includes desired traveling information, such as place of travel origin and travel destination, dates of travel and selection of travel a desired travel supplier, e.g., an airline or non-airline merchant. The travel office software application can capture the booking or travel request entered by the travel agent 14 and store the booking or travel request in an associated travel office storage medium, such as a database.

The travel agent 14 can then submit a travel itinerary or booking request, which includes the travel request, to one or more travel suppliers 16, e.g., an airline or a railroad company, for booking and confirmation of the travel itinerary request. The travel office software application can transmit the travel itinerary request to a selected travel supplier 16, e.g., an airline or railroad network. The travel agent 14 can communicate with the travel supplier 16 via an internet communication link using a web application or can communicate directly using a dedicated communication link (not shown). Those of ordinary skill in the art will readily recognize that other known communication means may instead or additionally be used.

The travel agent 14 is also adapted to generate a travel itinerary billing data file for transmission to the standalone billing platform 18 of the financial services provider 20. The travel agent 14 can communicate with the billing platform 18 via an internet communication link using a web application or can communicate directly using a dedicated communication link. Those of ordinary skill in the art will readily recognize that other known communication means may instead or additionally be used. For example, the travel agent 14 can also transmit the travel itinerary billing data file to the billing platform 18 through the larger financial services provider system 20 connected to the billing platform 18.

The booked travel itinerary billing data file submitted by the travel agent 14 includes data and information that will be included in the billing statement generated by the billing platform 18. The travel itinerary billing data file preferably includes data and information previously agreed to by the client 12 and financial services provider 20 for inclusion in the billing statement. The travel itinerary can include the traveler name, the traveler's company cost center, project code, invoice number, travel agent commission, etc.

The travel supplier 16 in the system 10 can have one or more machines that run or execute one or more software applications, including a web interface application and a travel supplier business travel account application. The travel supplier application is adapted to receive the booking request or travel itinerary request transmitted by the travel agent 14 for booking and confirmation. Those of ordinary skill in the art will readily recognize that there can be more than one travel supplier 16 providing travel services for the system 10. The travel supplier 16 can communicate with the travel agent 14 and the billing platform 18 via an internet communication link using a web application or can communicate directly using a dedicated communication link. Those of ordinary skill in the art will readily recognize that other known communication means may instead or additionally be used. For example, the travel supplier 16 can also transmit communicate data and information to the billing platform 18 through the larger financial services provider system 20 connected to the billing platform 18.

The travel supplier application is adapted to receive the travel itinerary request transmitted by the travel agent 14. The travel supplier application can confirm the travel itinerary request. The travel supplier application then transmits a confirmation to the travel agent 14. The travel supplier application also stores the confirmation and the received travel itinerary request in its associated travel supplier database storage. In this manner, the travel supplier 16 may subsequently access and transmit this information as needed.

The travel supplier 16, via its software application, is also adapted to generate a travel supplier charge file, that includes travel supplier charges for a confirmed travel itinerary request. The travel supplier can then transmit the travel supplier charge file to the financial services provider 20. In some cases, a travel supplier 16 may not submit a travel supplier charge file until after the client 10 has actually used the services provided by the travel supplier 16.

The travel supplier charge file can include data and information requested or required by the financial services provider 20 to settle the travel supplier's travel transaction charges. For example, the travel supplier charge file can include data and information about the confirmed travel itinerary request such as billing and pricing data, traveler's name, traveler's company and cost center information, travel dates and times, etc. The travel supplier charge file enables the financial services provider 20 to properly reconcile the travel supplier charge file to a corresponding travel agency invoice file received from the travel agent 14 and included in billing statements previously generated and sent to the client 12 via the billing platform 18.

The billing platform 18, shown in FIG. 1 is preferably an apparatus or component with one or more machines or servers running and executing software applications, including a web interface application and a business travel account billing application and reconciliation application. The billing platform 18 is preferably a standalone apparatus that can perform its functions, e.g., billing and reconciliation, independent of an associated financial services provider system 20, as shown in FIG. 1. Those of ordinary skill in the art will readily recognize that the billing platform 18 can be connected or associated with the financial services provider 20, to take advantage of existing infrastructure in the financial services provider system 20. For example, to take advantage of communications infrastructure that enables the financial services provider 20 to receive data and information from the travel agent 14 and the travel supplier 16.

The billing platform 18, via communication links and the business travel application, is adapted to receive and synchronize billing data files from both the travel agent 14 and from the financial services provider 20. The billing platform 18 can store received billing data files in an associated provider database or reconciliation database where they are subsequently accessible as needed for billing, reconciling, reporting and other billing platform functions. Thus, the billing platform 18 is able to generate an electronic billing statement for the client 12 that includes both the travel itinerary billing data file and any other billing data files provided by the financial services provider 20.

The billing platform 18 can communicate with the travel agent 14 and the financial services provider 20 via an internet communication link, though dedicated and direct communication links may instead or additionally be used. The billing platform 18 can communicate with the travel agent 14 and the financial services provider 20 via an internet communication link using a web application or can communicate directly using a dedicated communication link. Those of ordinary skill in the art will readily recognize that other known communication means may instead or additionally be used.

As described above, the billing platform 18 is adapted to receive billing data and information files from both the travel agent 14 relating to booked travel transactions and to receive billing data and information files from the financial services provider 20 relating to any type transaction. The billing platform 18, via its business travel account application and reconciliation apparatus is adapted to carry out and execute various functions and capabilities, including tracking, storing, billing and reconciling the combined billing data received from both the travel agent 14 and the financial services provider 20. The data files received provide a means for the billing platform 18 to generate billing statements and to reconcile the billed transactions.

The billing statement can be generated at the end of a billing period, e.g., monthly, weekly, or a defined day of month, etc., for submission to the client 12 for payment of the booked travel transactions. In a preferred aspect, the financial services provider 20 may bill the client 10 for the transaction before the travel supplier 16 provides the travel supplier charge file to the financial services provider 20 for the same transaction. In this manner, the financial services provider 20 can potentially receive payment from the client 12 prior to being billed by the travel supplier 16 for their travel supplier services to the client 12. Expediting the generation of the billing statement can result in an improved cash flow or float position for the financial services provider 20 when the company is paid for the billed travel transactions prior to receiving the corresponding travel supplier charges for the previously billed travel transactions.

The system and method for improved electronic billing and reconciling process for travel transactions can also result in additional capabilities, functions and features, including among others: A single electronic statement for all the customer's business travelers; Variable electronic billing statement frequency and date (monthly, fortnightly, weekly, daily, specified day of the month); Ability to create “adhoc” electronic statements when required; Detailed transaction data; Free format reference fields available for customer-specific data; Multi-level sorting and subtotaling options on the statement, including page throw by sort type; Choice of electronic statement designs available, offering differing fields/formats of transaction data; Open item billing—(unpaid transactions continue to be itemized on statement until paid); Ability to receive multiple copies to differing addressees; Electronic billing and AR/AP (data feed) reconciliation processes separated; An electronic billing statement which the client 12 can automatically feed into their general ledger system; Delayed payment charges, giving the client 12 the ability to pay the account later than the due date so long as they cover the cost to the financial services provider 20 of funding the debt; Market level interest rates for delayed payment charges can be overwritten at business travel account number level; Ability to dispute transactions and temporarily remove them from the ageing process; and Payment Power software tool available for billing support file manipulation.

Although the system 10 has been described in relation to the client 12 booking travel related expenses using a travel agent 14, the system 10 could be implemented wherein the client 12 interacts directly with the travel supplier 16. As such, the various systems and functions described above in relation to the travel agent 14 may instead be performed by the travel supplier 16.

Those of ordinary skill in the art will readily recognize that many of the functions and aspects of the system 10 can be implemented on networked computers, which may be connected for data communication via components of a network. The hardware of such computer platforms typically is general purpose in nature, albeit with an appropriate network connection for communication via the intranet, the Internet and/or other data networks.

As known in the data processing and communications arts, each such general-purpose computer typically comprises a central processor, an internal communication bus, various types of memory (RAM, ROM, EEPROM, cache memory, etc.), disk drives or other code and data storage systems, and one or more network interface cards or ports for communication purposes. The computer system also may be coupled to a display and one or more user input devices such as alphanumeric and other keys of a keyboard, a mouse, a trackball, etc. The display and user input element(s) together form a service-related user interface, for interactive control of the operation of the computer system. These user interface elements may be locally coupled to the computer system, for example in a workstation configuration, or the user interface elements may be remote from the computer and communicate therewith via a network. The elements of such a general-purpose computer system also may be combined with or built into routing elements or nodes of the network.

The software functionalities (e.g., many of the operations described above) involve programming of controllers, including executable code as well as associated stored data. The software code is executable by the general-purpose computer that functions as the particular computer. In operation, the executable program code and possibly the associated data are stored within the general-purpose computer platform. At other times, however, the software may be stored at other locations and/or transported for loading into the appropriate general-purpose computer system. Hence, the embodiments involve one or more software products in the form of one or more modules of code carried by at least one machine-readable medium. Execution of such code by a processor of the computer platform enables the platform to implement the system or platform functions, in essentially the manner performed in the embodiments discussed and illustrated herein.

As used herein, terms such as computer, server or machine readable medium refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in any computer(s). Volatile media include dynamic memory, such as main memory of such a computer platform. Physical transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the technology and processes disclosed herein may be implemented in various forms and examples, and that they may be applied in numerous applications, only some of which have been described herein. Those skilled in that art will recognize that the disclosed aspects may be altered or amended without departing from the true spirit and scope of the subject matter. It is intended by the following claims to claim any and all modifications and variations that fall within the true scope of the advantageous concepts disclosed herein.

1. A computer-readable medium having computer-executable instructions for generating and providing electronic billing statements, the computer-executable instructions performing the steps of:
receiving a first billing data file from a first computer;
receiving a second billing data file from a financial services provider computer;
generating an electronic billing statement using said first billing data file and said second billing data file; and
providing said electronic billing statement to a client computer.

2. The computer-readable medium of claim 1 wherein said first billing data file is a travel itinerary billing data file.

3. The computer-readable medium of claim 2 wherein said travel itinerary billing data file includes a traveler's name, company cost center, project code, invoice number, and travel agent commission.

4. The computer-readable medium of claim 1 wherein said first computer is a travel agency computer.

5. The computer-readable medium of claim 1 wherein said first computer is a travel supplier computer.

6. The computer-readable medium of claim 1 wherein said first computer is a client computer.

7. The computer-readable medium of claim 1 wherein said first billing data file includes a traveler profile for correlating billed travel data with a travel account.

8. A method of generating and providing an electronic billing comprising the steps of:
transmitting a travel transaction request to a first computer;
generating, at said first computer, a first billing data file in response to said travel transaction request;
transmitting said first billing data file to a second computer;
generating, at a third computer, a second billing data file;
transmitting said second billing data file to said second computer;
generating, at said second computer, an electronic billing statement using said first billing data file and said second billing data file; and
providing said electronic billing statement to a fourth computer.

9. The method of claim 8 wherein said fourth computer generates said travel transaction request.

10. The method of claim 9 wherein said travel itinerary billing data file includes a traveler's name, company cost center, project code, invoice number, and travel agent commission.

11. The method of claim 8 wherein said first computer is a travel agency computer.

12. The method of claim 8 wherein said first computer is a travel supplier computer.

13. The method of claim 8 wherein said first computer is a client computer.

14. The method of claim 8 wherein said first billing data file includes a traveler profile for correlating billed travel data with a travel account.

15. A system to generate and provide an electronic billing statement comprising:
a client computer;
a travel agent computer;
a financial service provider computer;
an electronic billing and reconciliation computer for receiving a first billing data file and a second billing data file, generating an electronic billing statement, and providing said electronic billing statement to said client computer.

16. The system of claim 15 further comprising a travel supplier computer.

17. The system of claim 16 wherein said travel supplier computer generates a charge file and provides said charge file to said financial service provider computer.

18. The system of claim 15 wherein said first billing data file is a travel itinerary billing data file.

19. The system of claim 18 wherein said travel itinerary billing data file includes a traveler's name, company cost center, project code, invoice number, and travel agent commission.

20. The system of claim 15 wherein said first billing data file includes a traveler profile for correlating billed travel data with a travel account.
